(19) United States
(12) Patent Application Publication
(10) Pub. No.: US 2018/0337572 A1
(43) Pub. Date: Nov. 22, 2018

(54) ROTARY ELECTRIC MACHINE

(71) Applicant: MITSUBISHI ELECTRIC CORPORATION, Chiyoda-ku (JP)

(72) Inventors: Yoshihiro MIYAMA, Chiyoda-ku (JP); Hideaki ARITA, Chiyoda-ku (JP)

(73) Assignee: MITSUBISHI ELECTRIC CORPORATION, Chiyoda-ku (JP)

(21) Appl. No.: 15/781,835

(22) PCT Filed: Jan. 19, 2017
(86) PCT No.: PCT/JP2017/001765

§ 371 Date: Jun. 6, 2018

(30) Foreign Application Priority Data
Feb. 3, 2016 (JP) 2016-018755

(51) Int. Cl. H02K 3/24; H02K 5/18; H02K 9/19; H02K 9/22

(52) U.S. Cl. CPC H02K 3/24; H02K 9/22; H02K 9/19; H02K 5/18

(57) ABSTRACT

A rotary electric machine includes a stator core, a stator coil, and a cooling portion. The stator core includes yoke portions and a plurality of tooth portions, and surrounds an outer periphery of a rotor. Each of the tooth portions has a distal end portion protruding radially inward from an inner peripheral surface of each of the yoke portions toward a center axis of the rotor. The stator coil includes a plurality of phase coil portions formed by winding a conductive wire around the stator core. The cooling portion is provided so as to be isolated from the stator core, and is configured to cool the stator coil in contact with the stator coil.

### TECHNICAL FIELD

The present invention relates to a rotary electric machine, which includes a cooling portion configured to cool a stator coil wound around a stator core.

### BACKGROUND ART

Hitherto, there has been known a rotary electric machine in which a coil end of a stator coil is brought into contact with a frame. With this configuration, heat transfer performance of the stator coil is enhanced, to thereby lower a temperature thereof (for example, see Patent Literature 1).

### CITATION LIST

### Patent Literature

[PTL 1] JP 2010-35310 A

### SUMMARY OF INVENTION

### Technical Problem

In the related-art rotary electric machine described above, copper loss in the stator coil can be reduced, but iron loss in a stator core cannot be reduced.

In such a rotary electric machine, there is a problem in that operation efficiency of the rotary electric machine cannot be improved in such a high-frequency operating range that the iron loss in the stator core is increased.

The present invention has been made in order to solve the above-mentioned problem, and has an object to provide a rotary electric machine, which is capable of reducing the copper loss in the stator coil and reducing the iron loss in the stator core with a simple configuration.

### Solution to Problem

According to one embodiment of the present invention, there is provided a rotary electric machine, including: a stator core, which surrounds an outer periphery of a rotor, and includes yoke portions, and a plurality of tooth portions each having a distal end portion protruding radially inward from an inner peripheral surface of each of the yoke portions toward a center axis of the rotor; a stator coil, which includes a plurality of phase coil portions formed by winding a conductive wire around the stator core; and a cooling portion, which is configured to cool the stator coil in contact with the stator coil, and is provided so as to be isolated from the stator core.

### Advantageous Effects of Invention

According to the rotary electric machine of the present invention, the cooling portion is configured to cool the stator coil in contact with the stator coil, and is provided so as to be isolated from the stator core. With such a simple configuration, the rotary electric machine can reduce copper loss in the stator coil, and also reduce iron loss in the stator core.

### BRIEF DESCRIPTION OF DRAWINGS

FIG. 1 is a sectional view for illustrating a motor according to a first embodiment of the present invention.

FIG. 2 is a perspective view for illustrating a stator, a frame, and a load-side bracket of FIG. 1.

FIG. 3 is a perspective view for illustrating a stator coil and coil fixing members of FIG. 1.

FIG. 4 is a perspective view for illustrating a heat sink of FIG. 1.

FIG. 5 is a sectional view for illustrating the coil fixing member taken along the line V-V of FIG. 1.

FIG. 6 is a perspective view for illustrating a configuration of a vicinity of a counter-load-side coil end portion of the motor according to the first embodiment of the present invention.

FIG. 7 is a perspective view for illustrating a stator, a frame, and a load-side bracket of a motor according to a second embodiment of the present invention.

FIG. 8 is a perspective view for illustrating a stator coil and coil fixing members of FIG. 7.

FIG. 9 is a sectional view for illustrating a motor according to a third embodiment of the present invention.

FIG. 10 is a sectional view for illustrating a motor according to a fourth embodiment of the present invention.

FIG. 11 is a perspective view for illustrating one of stator core pieces of a motor according to a fifth embodiment of the present invention.

FIG. 12 is a perspective view for illustrating a stator of a motor according to a sixth embodiment of the present invention.

FIG. 13 is an exploded perspective view for illustrating a stator thermal insulation case and a stator core of FIG. 12.

FIG. 14 is a perspective view for illustrating a rotor in a seventh embodiment of the present invention.

FIG. 15 is a sectional view for illustrating a modification example in which a thermal insulating member is inserted between a phase coil portion and a tooth portion of FIG. 5.

### DESCRIPTION OF EMBODIMENTS

Now, with reference to the drawings, a motor according to each embodiment of the present invention is described. In the drawings, the same or corresponding components and parts are denoted by the same reference symbols.

### First Embodiment

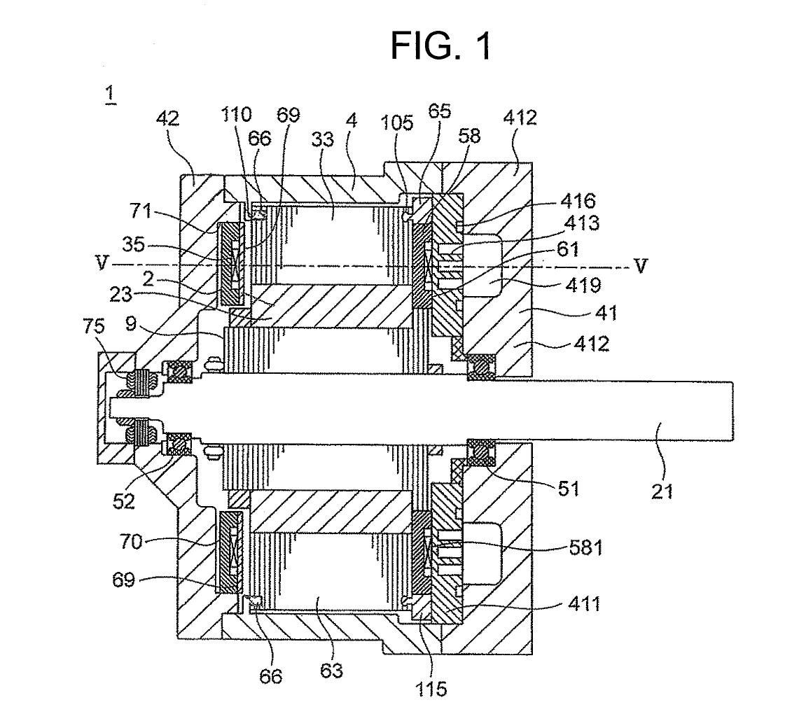

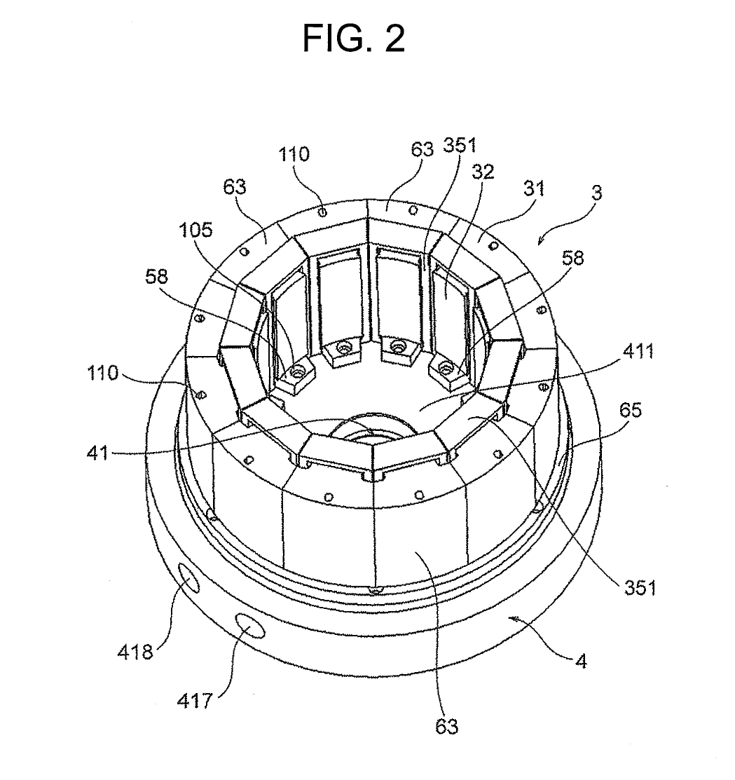

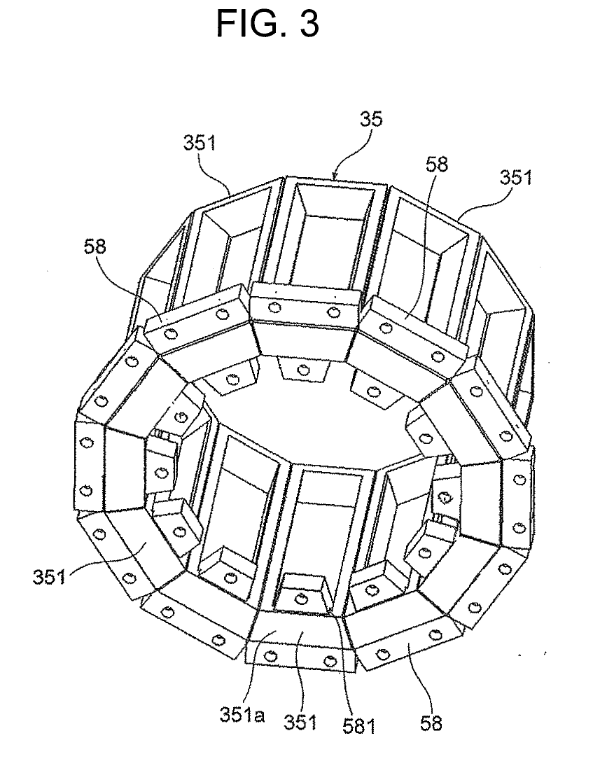

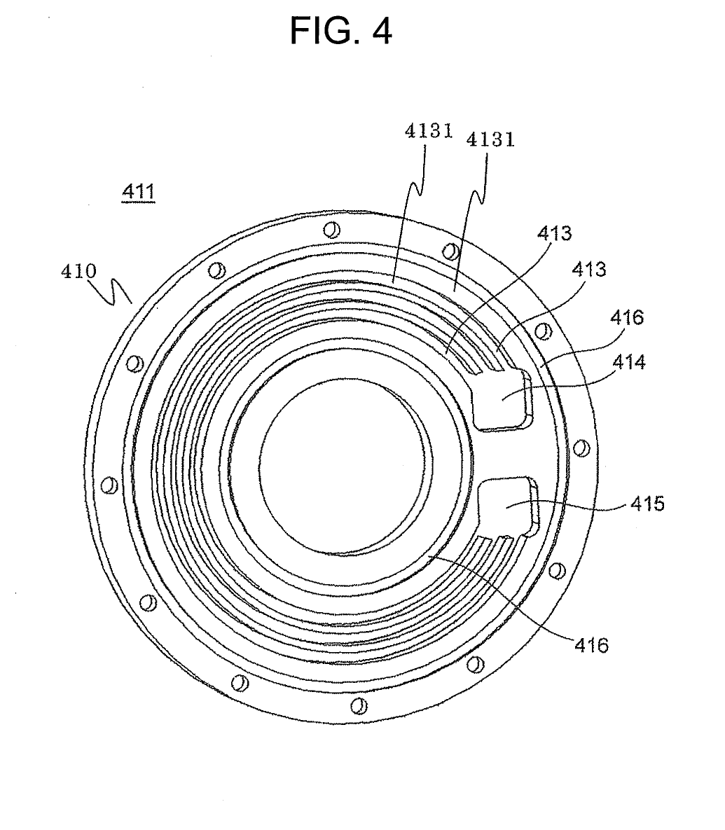

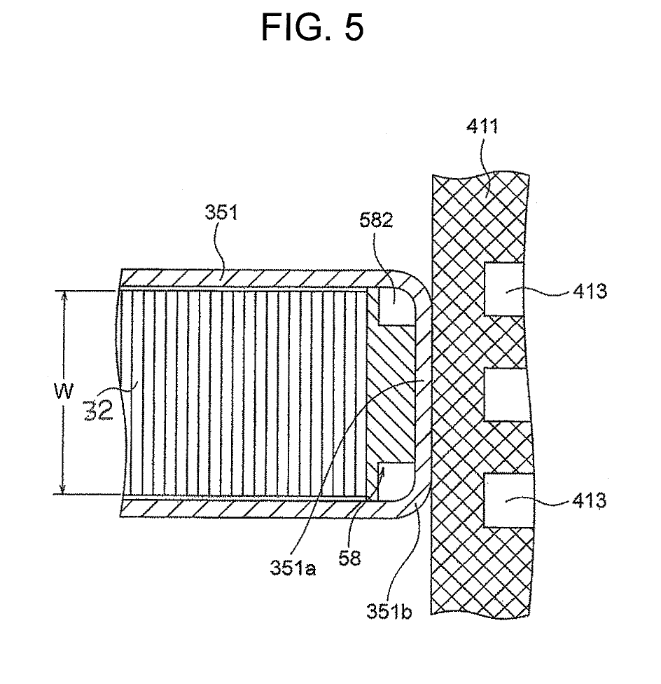

FIG. 1 is a sectional view for illustrating a motor 1 according to an first embodiment of the present invention. FIG. 2 is a perspective view for illustrating a stator 3, a frame 4, and a load-side bracket 41 of FIG. 1. FIG. 3 is a perspective view for illustrating a stator coil 35 and coil fixing members 58 of FIG. 1. FIG. 4 is a perspective view for illustrating a load-side heat sink 411 of FIG. 1 being a cooling portion. FIG. 5 is a sectional view for illustrating the coil fixing member 58 taken along the line V-V of FIG. 1.

The motor 1, which is a rotary electric machine, is a concentrated-winding permanent-magnet motor having ten poles and twelve slots. The motor 1 includes a rotor 2, the stator 3, the cylindrical frame 4, the load-side bracket 41, a counter-load-side bracket 42, and the coil fixing members 58. The stator 3 is provided so as to surround an outer periphery of the rotor 2 through a constant air gap between the rotor 2 and the stator 3. The cylindrical frame 4 is provided so as to surround an outer periphery of the stator 3 through an air gap, and is configured to hold and fix the stator 3. The load-side bracket 41 is a first bracket provided on a load side of the frame 4 in an axial direction. The counter-load-side bracket 42 is a second bracket provided on a side opposite to the load side of the frame 4 in the axial direction. The coil fixing members 58 is provided between the load-side bracket 41 and the stator 3.

The above-mentioned rotor 2 includes a shaft 21, a boss 9, and a rotor core 23. The shaft 21 is supported in a freely rotatable manner in the load-side bracket 41 and the counter-load-side bracket 42 through intermediation of a load-side bearing 51 and a counter-load-side bearing 52, respectively. The boss 9 is fitted to the shaft 21. The rotor core 23 is provided on an outer peripheral surface of the boss 9, and is formed of laminated steel sheets. Further, although not shown, ten permanent magnets are embedded in the rotor core 23 at vicinities of an outer peripheral surface of the rotor core 23 along a circumferential direction so that N-poles are arranged so as to be alternately directed inward and outward.

The stator 3 includes an annular stator core 33 and the stator coil 35. The stator coil 35 is wound around the stator core 33.

The stator core 33 includes 3n (n is an integer) number of stator core pieces 63 (twelve stator core pieces 63 in the first embodiment). Each of the stator core pieces 63, which is formed of laminated steel sheets, includes a circular-arc yoke portion 31 and a tooth portion 32. The tooth portion 32 is a salient pole portion formed on an inner peripheral surface of the yoke portion 31 so that a distal end portion thereof protrudes radially inward from a circumferential center portion toward a center axis of the stator 3.

The stator coil 35 includes a plurality of phase coil portions 351 corresponding to a U-phase, a V-phase, and a W-phase.

Each of the phase coil portions 351 having an annular shape is formed in such a manner that a rectangular conductive wire, which is a conductive wire, is wound around the tooth portion 32 by concentrated winding so that a gap is secured between each of the phase coil portions 351 and the tooth portion 32. Each of the phase coil portions 351 has an inner periphery larger than an outer periphery of the tooth portion 32 of each of the stator core pieces 63.

The load-side bracket 41 includes the load-side heat sink 411 and a base bracket 412. The load-side heat sink 411 is the cooling portion illustrated in FIG. 4, and is a first heat sink. The base bracket 412 has a diameter larger than that of the load-side heat sink 411, and covers one side surface of the load-side heat sink 411.

The load-side heat sink 411 includes a heat spreader portion 410, fin portions 4131, a refrigerant inflow port 414, a refrigerant outflow port 415, and two ring grooves 416. The heat spreader portion 410 is arranged on a coil fixing surface 61 side. The fin portions 4131 are formed on a surface on the base bracket 412 side so as to define refrigerant flow passages 413 extending in the circumferential direction in parallel to each other. The refrigerant inflow port 414 is formed in leading end portions of the refrigerant flow passages 413. The refrigerant outflow port 415 is formed in terminal end portions of the refrigerant flow passages 413. The two ring grooves 416 are formed on a radially inner side and a radially outer side of the refrigerant flow passages 413, respectively, so as to extend in the circumferential direction.

An insulating coating made of fluororesin is applied to the coil fixing surface 61 of the load-side heat sink 411 on the opposite side of the base bracket 412.

The base bracket 412 has a refrigerant flow passage 419, a refrigerant inflow port 417, and a refrigerant outflow port 418. The refrigerant flow passage 419 is formed in a surface on the load-side heat sink 411 side so as to extend in the circumferential direction. The refrigerant inflow port 417 is formed in a leading end portion of the refrigerant flow passage 419. The refrigerant outflow port 418 is formed in a terminal end portion of the refrigerant flow passage 419.

Under a state in which two O-rings (not shown) are arranged in the pair of ring grooves 416 respectively formed on a radially inner side and a radially outer side of the load-side heat sink 411, the load-side heat sink 411 and the base bracket 412 are fastened together with a bolt (not shown) in the axial direction, and thus are integrated with each other.

It is desired that the load-side heat sink 411 be formed of a highly thermally conductive member such as aluminum.

As illustrated in FIG. 3, each of the coil fixing members 58 includes a groove portion 581 arranged so as to correspond to a coil end portion of each of the phase coil portions 351 and configured to receive an interconnecting portion 351a of each of the phase coil portions 351 on the load-side bracket 41 side. Each of the coil fixing members 58 is fixed to the load-side heat sink 411 with a bolt (not shown).

An axial depth of the groove portion 581 is substantially equal to an axial length of the interconnecting portion 351a. Further, a radial length of the groove portion 581 is substantially equal to a radial length of the interconnecting portion 351a.

That is, the depth dimension of the groove portion 581 is substantially equal to a dimension in a transverse direction of the rectangular conductive wire having a rectangular cross section, and the radial length dimension of the groove portion 581 is substantially equal to a dimension in a longitudinal direction of the rectangular conductive wire.

As is apparent from FIG. 5, each coil fixing member 58 is manufactured so as to have a width W substantially equal to a width of an inner periphery of the phase coil portion 351, and positions and fixes the phase coil portion 351 along the circumferential direction. In order to avoid contact of the coil fixing member 58 with bent portions 351b of the phase coil portion 351, cutout portions 582 are formed in the coil fixing member 58 on both sides thereof in the circumferential direction and on the heat sink 411 side. Each of the cutout portions 582 is larger than a bending radius of each of the bent portions 351b.

Each coil fixing member 58 is manufactured with a thermal insulating member. However, each coil fixing member 58 may be manufactured by performing thermal insulation treatment on a surface of a conductive member.

Each of the stator core pieces 63 of the stator core has a circular load-side pin hole 105 and a circular counter-load-side pin hole 110 formed on the load side and the counter load side of a root portion of the tooth portion 32, respectively.

The stator core pieces 63 of the stator core 33 are arranged on a counter-load-side surface of the load-side heat sink 411 through intermediation of a stator base 65 having an annular shape, and the phase coil portions 351 are inserted between the tooth portions 32 to form an annular shape.

The stator base 65 having an annular shape is made of a plastic having a low thermal conductivity such as polyphenylenesulfide (PPS), polyetheretherketone (PEEK), or fluororesin. Further, the stator base 65 includes twelve stator base pin portions 115 on a contact surface with the stator core 33, and the load sides of the stator core pieces 63 are positioned by fitting the load-side pin holes 105 to the stator base pin portions 115.

It is desired that the stator base 65 be made of a material having high heat resistance. Further, in the above-mentioned example, the plastic is given as an example. However, the stator base 65 may be made of, for example, a thermal insulating inorganic material, glass wool, or a vacuum thermal insulating material.

Further, twelve stator pressing portions 66 each having an L shape are formed on the inner peripheral surface on the counter load side of the frame 4 at equal intervals in the circumferential direction. When the frame 4 is to be fixed to the load-side bracket 41, the stator pressing portions 66 are inserted into the counter-load-side pin holes 110 of the stator core pieces 63, respectively. As a result, the stator core pieces 63 are sandwiched between the stator pressing portions 66 and the stator base 65, which is a thermal insulating member, under a state in which the stator core pieces 63 are pressed toward the load-side bracket 41 side in the axial direction by elastic forces of the stator pressing portions 66. Further, the stator core pieces 63 are thermally insulated from the load-side heat sink 411 and are fixed. That is, the stator core 33 and the load-side heat sink 411, which is the cooling portion, are isolated from each other through the stator pressing portions 66 and the stator base 65 being a heat insulating member. Further, the stator core 33 is fixed to the cylindrical frame 4 in such a manner that both axial end surfaces of the stator core 33 are sandwiched in an axial direction.

Further, the stator core 33 is arranged in the frame 4 with the air gap, and is thermally insulated from the frame 4 by an air space. That is, the outer peripheral surface of the stator core 33 and the inner peripheral surface of the frame 4 are prevented from being brought into contact with each other in a radial direction.

In this example, a thermal insulating air filled in the air gap thermally insulates the stator core 33 and the frame 4 from each other. In a case of providing a thermal insulating member made of glass wool, a carbonized cork, urethane foam, a vacuum thermal insulating material, or the like, an effect of thermal insulation can be further enhanced.

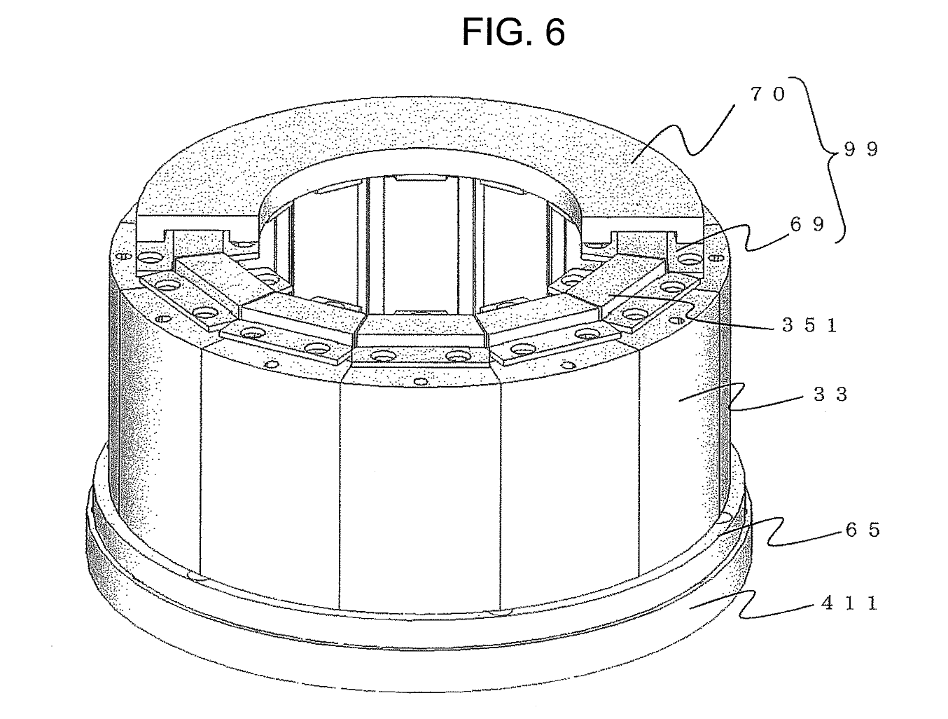

Further, as illustrated in FIG. 6, on the counter load side of each phase coil portion 351 of the stator coil 35, a counter-load-side coil inner periphery fixing member 69 is arranged between an inner surface of the phase coil portion 351 and a counter-load-side end surface of the tooth portion 32.

Further, one counter-load-side coil outer periphery fixing member 70 having a ring shape and a C-shaped cross section is arranged so as to be opposed to the counter-load-side coil inner periphery fixing members 69. Counter-load-side end portions of the phase coil portions 351 are sandwiched between the counter-load-side coil inner periphery fixing members 69 and the counter-load-side coil outer periphery fixing member 70. Each of the counter-load-side coil inner periphery fixing members 69 is fixed to the counter-load-side coil outer periphery fixing member with a bolt or the like (not shown), to thereby form a counter-load-side coil fixing member 99.

When the counter-load-side bracket 42 is mounted to the frame 4, the counter-load-side coil outer periphery fixing member 70 is fitted in a coil fixing groove 71 formed in the counter-load-side bracket 42. Thus, the counter load side of the stator coil 35 is fixed.

In the coil fixing groove 71 of the counter-load-side bracket 42, the counter-load-side coil outer periphery fixing member 70 is fitted with an air gap portion in the axial direction. The air gap portion may be filled with an elastic member.

Further, at counter-load-side end portions of the counter-load-side bracket 42 and the shaft 21, a rotational position sensor 75 configured to detect a rotational position of the shaft 21 is mounted.

It is desired that the elastic member be formed of, for example, a metal mesh or a metal spring. The elastic member may be made of rubber, a sponge, or a combination of those materials.

In the motor 1 according to the first embodiment, the phase coil portions 351 receive a current from a power supply unit.

As a result, a rotating magnetic field is generated in the stator core 33, and the rotating magnetic field attracts the rotor 2 to cause the rotor 2 to rotate. The shaft 21 of the rotor 2 is also rotated, and torque of the shaft 21 is transmitted to the load side.

According to the above-mentioned motor 1 of the first embodiment, both of the coil fixing members 58 and the stator base 65, which are interposed between the stator core 33 and the load-side heat sink 411, are formed of the thermal insulating members, and the stator core 33 is thermally insulated from the load-side heat sink 411. Accordingly, due to heat generation, which results from iron loss caused in the stator core 33 by a magnetic flux of a field magnet produced along with drive of the motor 1, and due to a change in magnetic flux caused by energizing, a temperature of the stator core 33 is raised, and a resistivity of the stator core 33 is increased. Thus, eddy current loss is reduced, with the result that iron loss in the stator core 33 is reduced.

Further, as illustrated in FIG. 5, in the stator coil 35, the interconnecting portion 351a of each of the phase coil portions 351 is held in surface contact with the heat sink 411. The stator coil 35 has such structure that, as a result of cooling of the stator coil 35, copper loss in the stator coil 35 is reduced, and that heat is directly radiated to the load-side heat sink 411 without being radiated through the stator core 33. Accordingly, a temperature of the stator core 33 can be raised irrespective of a heat-resistant temperature of the stator coil 35.

In addition, as illustrated in FIG. 5, a gap is formed between the stator coil 35 and each tooth portion 32 of the stator core 33, and a space between the stator coil 35 and each tooth portion 32 of the stator core 33 is also thermally insulated by the air that is a thermal insulating medium. Accordingly, the stator coil 35 is less liable to receive heat of the stator core 33. As a result, temperature rise of the stator coil 35 is further reduced, and thus a resistivity of the stator coil 35 can be reduced. Therefore, it is possible to reduce joule loss caused by energizing the stator coil 35.

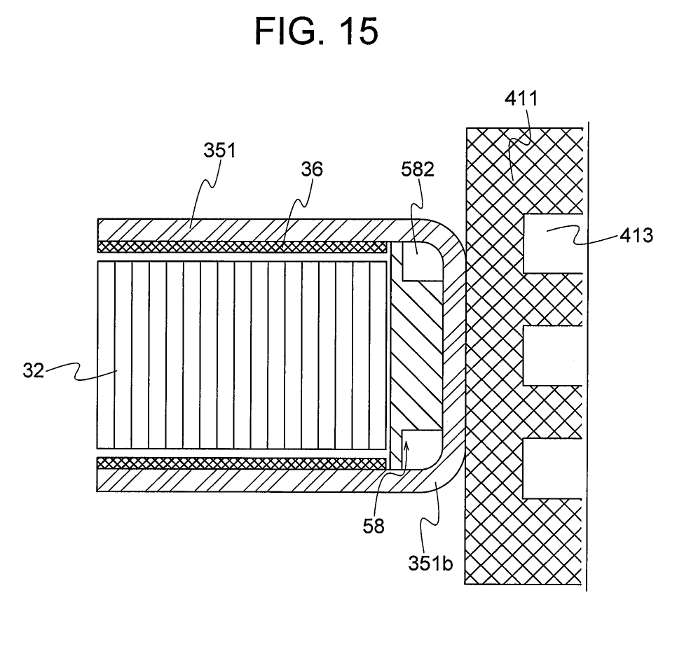

Further, in a case of providing a thermal insulating member made of rubber, glass wool, a carbonized cork, urethane foam, a vacuum thermal insulating material, or the like between the stator coil 35 and a circumferential side surface of each tooth portion 32 of the stator core 33, the effect of thermal insulation can be further enhanced. That is, as illustrated in FIG. 15, a thermal insulating member 36 may be inserted between each of the phase coil portions 351 of the stator coil 35 and each of the tooth portions 32 of the stator core 33. The thermal insulating member 36 thermally separates each of the phase coil portions 351 and the stator core 33 from each other.

Further, in a case of the structure of the related-art motor in which an outer periphery of a stator core is fixed to a cooler by shrinkage fit, stress is applied to the stator core, and hysteresis loss in a member, such as a magnetic steel sheet constricting the stator core, is increased.

In contrast, according to the motor 1 of the first embodiment, the air gap is formed between the stator core 33 and the frame 4, and the air gap absorbs thermal expansion of the stator core 33 in the radial direction. Accordingly, the stress on the stator core 33 is suppressed, and thus hysteresis loss in the stator core 33 can be reduced.

Further, the air is interposed in the air gap between the stator core 33 and the frame 4, and thus heat of the stator core 33 is less liable to be conducted to the frame 4. Accordingly, because of heat generation resulting from iron loss caused in the stator core 33, the temperature of the stator core 33 is further raised, and thus the resistivity of the stator core 33 is increased. Therefore, the eddy current loss is reduced, with the result that the iron loss in the stator core 33 can be further reduced.

The counter-load-side coil outer periphery fixing member 70 is formed of an annular integrated member. However, the counter-load-side coil outer periphery fixing member 70 may be formed of twelve divided members corresponding to the phase coil portions 351.

Also in this case, the same effect is attained.

Further, the number of the refrigerant flow passages 413 of the heat sink 411 is not limited to three as in the case illustrated in FIG. 4. The number of the refrigerant flow passages 413 may be one or two. In such structure, pressure loss in the refrigerant flow passages 413 can be reduced.

### Second Embodiment

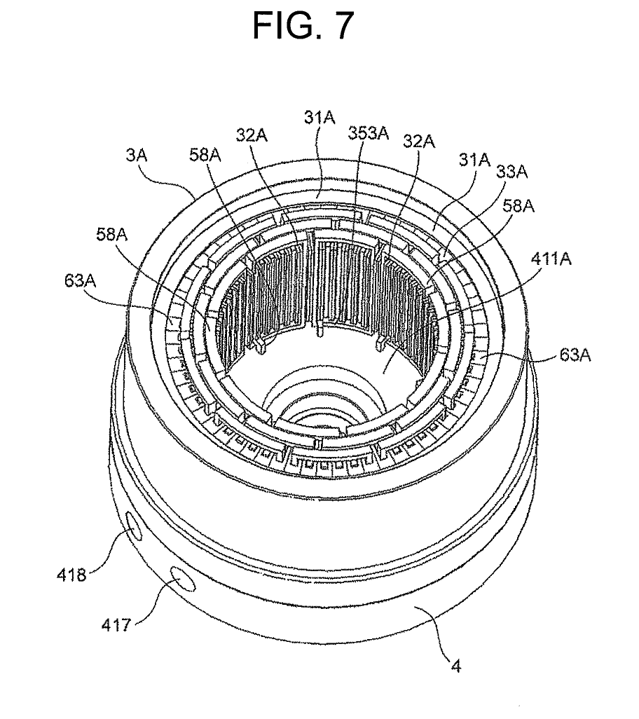

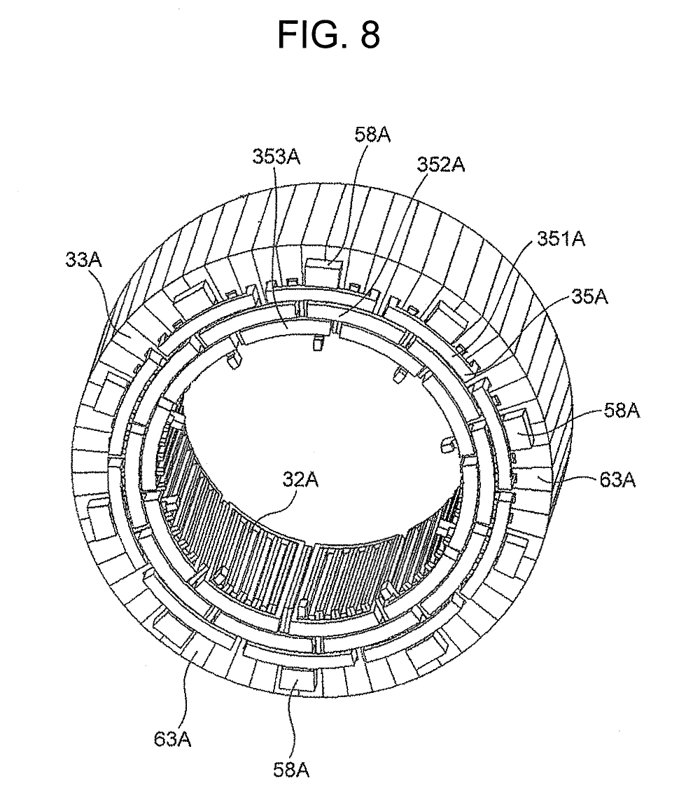

FIG. 7 is a perspective view for illustrating the stator 3 of the motor 1 according to a second embodiment of the present invention. FIG. 8 is a perspective view for illustrating a relationship between a stator coil 35A and coil fixing members 58A of the motor 1 according to the second embodiment of the present invention.

In FIG. 7, the stator core 33A includes sixty tooth portions 32A, and the stator core 33A includes sixty stator core pieces 63A that are formed by dividing the stator core 33A into sixty equal pieces in the circumferential direction so as to include circumferential center portions of the tooth portions 32A within divided surfaces.

In FIG. 8, the stator coil 35A is formed by winding a conductive wire such that, in a sixth slot from a slot (space between the adjacent tooth portions 32A) in which one circumferential end of the conductive wire is inserted, another circumferential end of the conductive wire is inserted.

Ten coil fixing members 58A are arranged at equal intervals in the circumferential direction. When seen from the load side of the motor 1, each of the coil fixing members 58A receives a circumferential center portion of a radially outermost phase coil portion 351A, a counterclockwise-side end portion of a phase coil portion 352A located in a center region in the radial direction, and a clockwise-side end portion of a radially innermost phase coil portion 353A. The coil fixing members 58A and the phase coil portions 351A, 352A, and 353A are fixed to a load-side heat sink 411A.

Ten counter-load-side coil inner periphery fixing members (not shown) are arranged so as to be opposed to positions of the coil fixing members 58A arranged along the circumferential direction. Similarly to the coil fixing members 58A, when seen from the load side of the motor 1, each of the counter-load-side coil inner periphery fixing members also receives and fixes the circumferential center portion of the radially outermost phase coil portion 351A, the counterclockwise-side end portion of the phase coil portion 352A located in the center region in the radial direction, and the clockwise-side end portion of the radially innermost phase coil portion 353A.

Thus, the motor 1 is constructed as a distributed-winding motor having ten poles and sixty slots.

Winding of the stator coil 35A is formed to have the air gap so as to prevent the stator coil 35A from being brought into contact with the stator core 33A.

Other components are the same as those of the motor 1 according to the first embodiment.

The distributed-winding motor 1 according to the second embodiment also provides the same effect as that of the concentrated-winding motor 1 according to the first embodiment.

### Third Embodiment

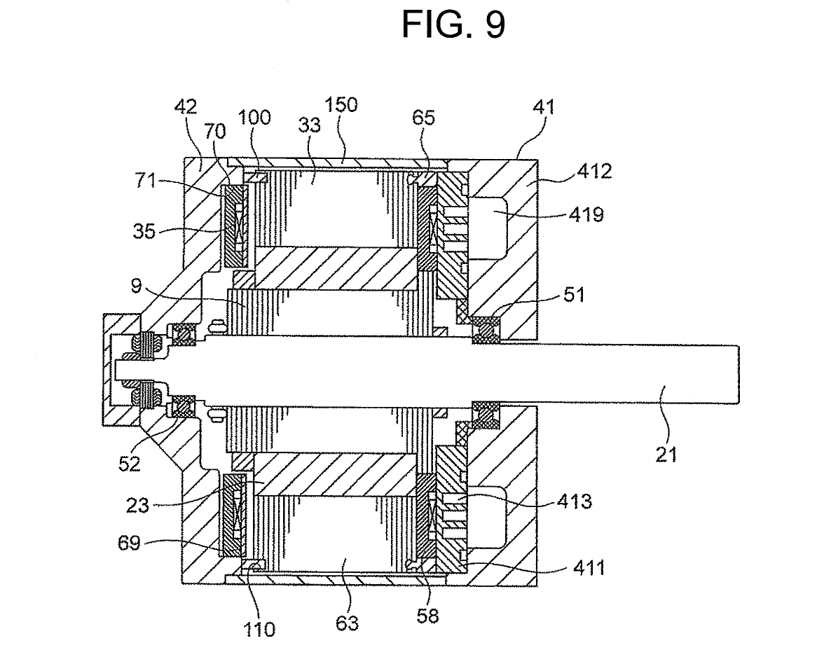

FIG. 9 is a sectional view for illustrating the motor 1 according to a third embodiment of the present invention.

In the motor 1 according to the third embodiment, the counter-load-side bracket 42 includes twelve pin portions 100 in the circumferential direction.

The pin portions 100 of the counter-load-side bracket 42 are respectively fitted into the counter-load-side pin holes 110 formed in the stator core pieces 63. The pin portions 100 position the stator core pieces 63, and push the stator core pieces 63 in the axial direction, to thereby sandwich and fix the stator core pieces 63 together with the load-side bracket 41.

The counter-load-side bracket 42 is coupled to the load-side bracket 41 with bolts 150 that are a plurality of coupling members arranged on a radially outer side of the stator core 33 at equal intervals in the circumferential direction.

Other components are the same as those of the motor 1 according to the first embodiment.

According to the motor 1 of the third embodiment, the same effect as that of the motor 1 according to the first embodiment can be obtained. Further, the counter-load-side bracket 42 positions the stator core pieces 63, and is fixed to the load-side bracket 41 with the bolts 150 being the coupling members. Accordingly, the frame 4 used in the motor 1 according to the first embodiment and the second embodiment is not needed. As a result, a radial dimension can be reduced, and reduction in weight can be achieved.

### Fourth Embodiment

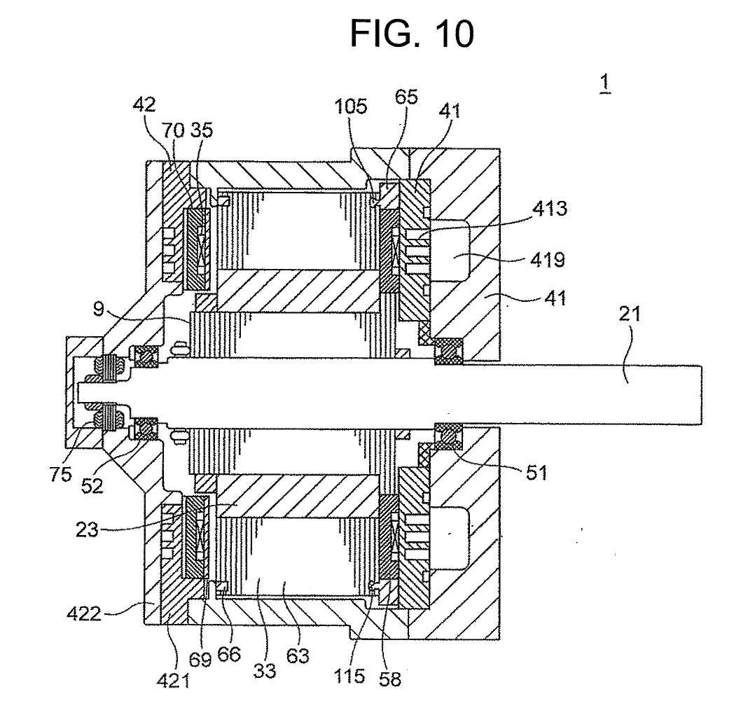

FIG. 10 is a sectional view for illustrating the motor 1 according to the fourth embodiment of the present invention.

In the motor 1 according to the fourth embodiment, the counter-load-side bracket 42 includes a counter-load-side heat sink 421, which is a second heat sink, and a counter-load-side bracket base 422.

The counter-load-side heat sink 421 has three parallel refrigerant flow passages at positions corresponding to the stator coil 35 in the axial direction.

After liquid packing is applied to the counter-load-side heat sink 421 and the counter-load-side bracket base 422, the counter-load-side heat sink 421 and the counter-load-side bracket base 422 are tightly fixed to each other.

The counter-load-side coil outer periphery fixing member 70 is made of a plastic having a low thermal conductivity such as polyphenylenesulfide (PPS), polyetheretherketone (PEEK), or fluororesin.

Other components are the same as those of the motor 1 according to the first embodiment.

According to the motor 1 of a fourth embodiment of the present invention, the same effect as that of the motor according to the first embodiment can be obtained, and both axial end portions of the stator coil 35 are cooled by the load-side heat sink 411 and the counter-load-side heat sink 421 that are liquid-cooled types. Accordingly, cooling performance is enhanced, and temperature rise of the stator coil 35 can be further suppressed.

Although not shown, it is preferred that the refrigerant flow passages of the counter-load-side heat sink 421 and the refrigerant flow passages of the load-side heat sink 411 be connected through a refrigerant forward passage and a refrigerant return passage formed in the frame 4.

With this configuration, one refrigerant inflow port and one refrigerant outflow port are sufficient to supply the refrigerant to the motor 1. Thus, downsizing can be achieved.

The stator core 33 is fixed under a state of being thermally insulated from the counter-load-side heat sink 421, which is the second heat sink, by the counter-load-side coil outer periphery fixing member 70 being the thermal insulating member.

### Fifth Embodiment

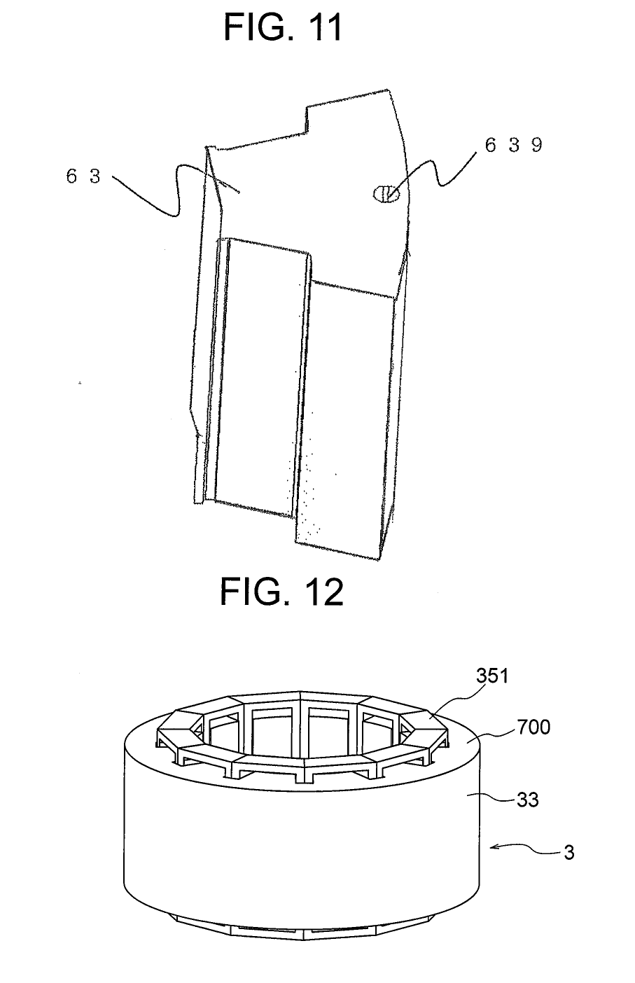

FIG. 11 is a perspective view for illustrating one of the stator core pieces 63 of the motor 1 according to a fifth embodiment of the present invention.

A pin insertion hole 639 of each of the stator core pieces 63 is an oval hole elongated in the radial direction, and the stator base pin portion 115 is inserted into the pin insertion hole 639.

Other components are the same as those in the first embodiment.

According to the motor 1 of the fifth embodiment, the pin insertion hole 639 is the oval hole that allows the stator base pin portion 115 to move in the radial direction when the stator core 33 is increased in diameter due to thermal expansion. Accordingly, stress on the stator core 33 is suppressed.

Thus, increase in hysteresis loss in the stator core 33 can be prevented, and durability of the motor 1 can be enhanced.

### Sixth Embodiment

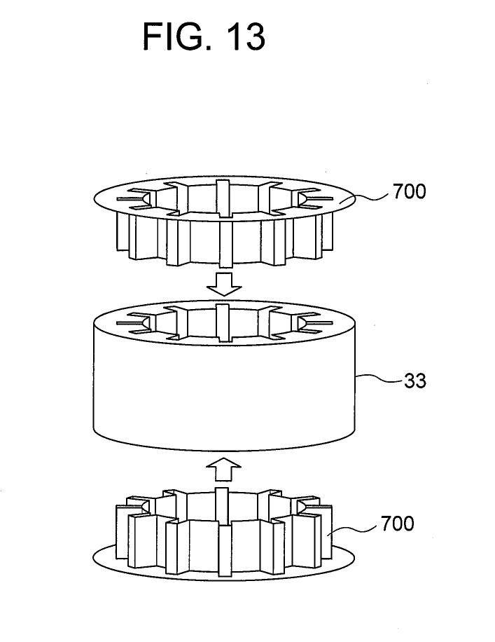

FIG. 12 is a perspective view for illustrating the stator 3 of the motor 1 according to a sixth embodiment of the present invention. FIG. 13 is an exploded perspective view for illustrating a stator thermal insulation case 700 and the stator core 33 of FIG. 12.

In the sixth embodiment, the stator core 33 is covered with the stator thermal insulation case 700, and is thermally insulated from an outside. The stator coil 35 is covered with and fixed to the stator thermal insulation case 700.

The stator thermal insulation case 700 includes two pieces divided in the axial direction. The two pieces of the stator thermal insulation case 700 are mounted to the stator core 33 so as to sandwich the stator core 33 from both axial end surfaces of the stator core 33.

The stator thermal insulation case is made of a plastic having a low thermal conductivity such as PPS, PEEK, or fluororesin, or an inorganic material having a low thermal conductivity, glass wool, a carbonized cork, urethane foam, a vacuum thermal insulating material, or the like.

A cooling oil is stored in a container surrounded by the frame 4, the load-side bracket 41, and the counter-load-side bracket 42.

The cooling oil is cooled through the load-side bracket 41.

Further, in the sixth embodiment, the coil fixing members 58, the counter-load-side coil inner periphery fixing members 69, and the counter-load-side coil outer periphery fixing member 70 are not needed, and other components are the same as those of the motor 1 according to the first embodiment.

According to the motor 1 of the sixth embodiment, the rotor 2 is rotated along with operation of the motor 1 to diffuse the cooling oil in the motor 1. Thus, the rotor 2 and the stator coil 35 are cooled. Meanwhile, the stator core 33 is thermally insulated from the cooling oil by the stator thermal insulation case 700. Accordingly, the temperature of the stator core 33 is raised due to iron loss, and thus electric resistance thereof is increased, with the result that the eddy current loss is reduced.

In the above-mentioned embodiment, the cooling oil is stored in the container surrounded by the frame 4, the load-side bracket 41, and the counter-load-side bracket 42, and is not taken out to the outside. However, the cooling oil may be taken out to the outside of the motor 1 by an oil pump or the like through a pipe mounted to the frame 4 or the like, and maybe returned to the motor 1 after being cooled by an external cooler. In this case, the load-side bracket 41 has no refrigerant flow passage, and is formed of an integrated member. Consequently, the load-side bracket 41 has a simple configuration, and durability of the motor 1 can be enhanced.

Instead of constructing the stator thermal insulation case 700 by two divided pieces, the stator core pieces 63 may be inserted into the integrally-molded stator thermal insulation case 700 from an outer peripheral side of the stator thermal insulation case 700.

When such a configuration is adopted, the stator thermal insulation case 700 becomes seamless, and thermal insulation performance can be further enhanced. Accordingly, an effect of reducing loss in the stator core 33 can be enhanced.

Further, in the sixth embodiment, the stator thermal insulation case 700 does not cover the outer peripheral surface of the stator core 33, but may cover also the outer peripheral surface of the stator core 33.

With this, the stator core 33 can be prevented from being cooled by the cooling oil from the outer peripheral side, and the effect of reducing loss in the stator core 33 can be further enhanced.

### Seventh Embodiment

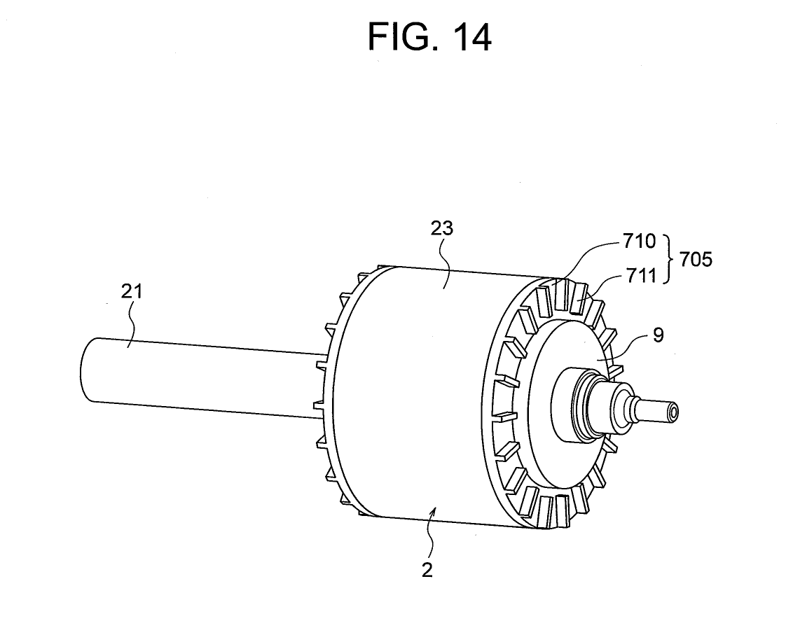

FIG. 14 is a perspective view for illustrating the rotor 2 according to a seventh embodiment of the present invention.

In the seventh embodiment, a fan 705 is provided on each axial side of the rotor core 23 of the rotor 2. In positions of the frame 4, which are opposed to the fan 705 and correspond to portions between the adjacent phase coil portions 351, twelve ventilation holes (not shown) on each side, that is, twenty-four ventilation holes in total are formed at equal intervals.

The fan 705 includes a disc-shaped plate 710, and nineteen plate-shaped vane portions 711 formed on one surface of the plate 710 to extend in the radial direction. The fan 705 constructs a centrifugal fan.

The load-side bracket 41 has no refrigerant flow passage 419, and is formed of an integrated member.

Other components are the same as those of the motor 1 according to the sixth embodiment.

According to the motor 1 of the seventh embodiment, the rotor 2 is rotated along with operation of the motor 1, and the fan 705 is rotated. An airflow generated by the fan 705 flows against the coil end portion of the stator coil 35, to thereby cool the stator coil 35.

The twenty-four ventilation holes are formed in the frame 4 at the positions corresponding to the portions between the adjacent phase coil portions 351. Accordingly, the airflow, which has passed through between the phase coil portions 351 to cool the coil end portion, is discharged to the outside of the motor 1 through the ventilation holes, thereby being capable of lowering a temperature in the motor 1.

The stator core 33 is thermally insulated from the cooling air by the stator thermal insulation case 700. Accordingly, the temperature of the stator core 33 is lowered due to iron loss, and thus electric resistance thereof is increased. Thus, eddy current loss is reduced.

In the motor 1 according to each of the above-mentioned embodiments, the permanent magnets are embedded in the rotor core 23 of the rotor 2, but the permanent magnets may be provided on a surface of the rotor core 23.

Further, as the motor, there may be used a motor having no permanent magnet, such as a switched reluctance motor or a synchronous reluctance motor, or an induction motor having a conductor bar in place of the permanent magnets.

Further, the coil fixing members 58 and the stator base 65 may be formed of an integrated member.

When this configuration is adopted, the number of components can be reduced, and mounting portions can be reduced. Thus, downsizing of the motor 1 can be achieved.

Further, in the stator coil 35, the rectangular conductive wire is used as the conductive wire, but a round wire may be used.

Further, it is only required that the coil fixing members 58 tightly fix the coil end portions of the phase coil portions 351 of the stator coil 35 to the load-side heat sink 411. Further, the groove portion 581 of each of the coil fixing members 58 may have a shape other than a C-shape. For example, a U-shape or a trapezoidal shape may be adopted.

Further, the number of the refrigerant flow passages 413 of the load-side heat sink 411 is not limited to three as in the case illustrated in FIG. 4. The number of the refrigerant flow passages 413 may be four or more.

According to this configuration, surface areas of the refrigerant flow passages 413 can be increased, and heat exchange performance can be enhanced.

Further, airtightness of the refrigerant flow passages 413 of the load-side heat sink 411 is secured by the two O-rings. However, the airtightness maybe secured using, for example, liquid packing or a metallic gasket.

Further, a surface of the coil fixing surface 61 of the load-side heat sink 411 may be insulated with a silicone resin coating or anodized aluminum, or a separate insulating member may be provided on the surface of the coil fixing surface 61.

Further, in each of the embodiments, the load-side heat sink 411 being the cooling portion is held in contact with the load-side coil end portions of the phase coil portions 351. However, the cooling portion may be arranged so as to be held in contact with counter-load-side coil end portions.

In this case, the coil fixing members 58 are also arranged on the counter load side.

Further, it is not required to fix the coil end portions of all of the phase coil portions 351 to the heat sink 411 by the respective coil fixing members 58. Only one phase coil portion 351 may be fixed to the heat sink 411 by the coil fixing member 58.

Further, two or more coil fixing members 58 may be mounted to one phase coil portion 351.

According to this configuration, the degree of tightness in fixing the coil end portion of the phase coil portion 351 to the heat sink 411 is increased. Thus, cooling performance is enhanced, and hence temperature fluctuation can be reduced.

Further, the stator core 33 is formed of the plurality of stator core pieces 63, but may be formed of a continuously-connected integrated member.

Further, the present invention is applicable not only to the motor 1 but also to a generator and a generator motor, which are rotary electric machines.

### REFERENCE SIGNS LIST

1 motor (rotary electric machine), 2 rotor, 3 stator, 4 frame, 9 boss, 23 rotor core, 31 yoke portion, 32, 32A tooth portion (salient pole portion), 33, 33A stator core, 35, 35A stator coil, 36 thermal insulating member, 41 load-side bracket (first bracket), 42 counter-load-side bracket (second bracket), 58, 58A coil fixing member, 61 coil fixing surface, 63, 63A stator core piece, 65 stator base, 66 stator pressing portion, 69 counter-load-side coil inner periphery fixing member, 70 counter-load-side coil outer periphery fixing member, 71 coil fixing groove, 75 rotational position sensor, 99 counter-load-side coil fixing member, 100 pin portion, 105 load-side pin hole, 110 counter-load-side pin hole, 115 stator base pin portion, 150 bolt (coupling member), 351, 351A phase coil portion, 410 heat spreader portion, 411, 411A load-side heat sink (first heat sink, cooling portion), 412 base bracket, 413 refrigerant flow passage, 414 refrigerant inflow port, 415 refrigerant outflow port, 416 ring groove, 417 refrigerant inflow port, 418 refrigerant outflow port, 419 refrigerant flow passage, 421 counter-load-side heat sink (second heat sink), 422 counter-load-side bracket base, 581 groove portion, 639 pin insertion hole

1-13. (canceled)

14. A rotary electric machine, comprising:
a stator core, which surrounds an outer periphery of a rotor, and includes yoke portions, and a plurality of tooth portions each having a distal end portion protruding radially inward from an inner peripheral surface of each of the yoke portions toward a center axis of the rotor;
a stator coil, which includes a plurality of phase coil portions formed by winding a conductive wire around the stator core; and
a cooling portion, which is configured to cool the stator coil in contact with the stator coil, and is provided to be isolated from the stator core,
wherein the stator core and the cooling portion are isolated and thermally insulated from each other through a heat insulating member, and
wherein the heat insulating member is held in contact with a first end surface of the stator core in an axial direction, and with a second end surface of the cooling portion in the axial direction.

15. The rotary electric machine according to claim 14,
wherein a thermal insulating member is inserted between each of the phase coil portions and the stator core, and
wherein the thermal insulating member thermally isolates the each of the phase coil portions and the stator core from each other.

16. The rotary electric machine according to claim 14,
wherein the cooling portion includes a first heat sink that is provided to be opposed to the first end surface of the stator core in an axial direction of the stator core, and
wherein a coil end portion of each of the phase coil portions is fixed to the first heat sink in a surface-contact state by a coil fixing member that is provided at the coil end portion of each of the phase coil portions, and has thermal insulation performance.

17. The rotary electric machine according to claim 16,
wherein each of the phase coil portions is formed into a ring shape by winding the conductive wire around each of the plurality of tooth portions by concentrated winding, and
wherein the coil fixing member includes a groove portion configured to receive the coil end portion from an inner side of each of the phase coil portions.

18. The rotary electric machine according to claim 16, wherein an air gap is formed between an outer peripheral surface of the stator core and an inner peripheral surface of a cylindrical frame provided to surround the stator core.

19. The rotary electric machine according to claim 18,
wherein the stator core is fixed to the frame such that both axial end surfaces of the stator core are sandwiched in the axial direction, and
wherein the outer peripheral surface of the stator core and the inner peripheral surface of the frame are prevented from being brought into contact with each other in a radial direction.

20. The rotary electric machine according to claim 16, wherein the first heat sink has a refrigerant flow passage.

21. The rotary electric machine according to claim 14, wherein a thermal insulating medium is interposed between the conductive wire and the each of the plurality of tooth portions.

22. A rotary electric machine, comprising:
a stator core, which surrounds an outer periphery of a rotor, and includes yoke portions, and a plurality of tooth portions each having a distal end portion protruding radially inward from an inner peripheral surface of each of the yoke portions toward a center axis of the rotor;
a stator coil, which includes a plurality of phase coil portions formed by winding a conductive wire around the stator core; and
a cooling portion, which is configured to cool the stator coil in contact with the stator coil, and is provided to be isolated from the stator core,
wherein the cooling portion includes a first heat sink that is provided to be opposed to a first end surface of the stator core in an axial direction of the stator core,
wherein a coil end portion of each of the phase coil portions is fixed to the first heat sink in a surface-contact state by a coil fixing member that is provided at the coil end portion of each of the phase coil portions, and has thermal insulation performance,
wherein the phase coil portions are formed by winding the conductive wire over the plurality of tooth portions by distributed winding, and
wherein the coil fixing member includes a groove portion configured to receive the coil end portion from an inner side of each of the phase coil portions in the axial direction of the stator core.

23. The rotary electric machine according to claim 22, wherein an air gap is formed between an outer peripheral surface of the stator core and an inner peripheral surface of a cylindrical frame provided to surround the stator core.

24. The rotary electric machine according to claim 22, wherein the first heat sink has a refrigerant flow passage.

25. The rotary electric machine according to claim 22, wherein a thermal insulating medium is interposed between the conductive wire and the each of the plurality of tooth portions.

26. A rotary electric machine, comprising:
a stator core, which surrounds an outer periphery of a rotor, and includes yoke portions, and a plurality of tooth portions each having a distal end portion protruding radially inward from an inner peripheral surface of each of the yoke portions toward a center axis of the rotor;
a stator coil, which includes a plurality of phase coil portions formed by winding a conductive wire around the stator core; and
a cooling portion, which is configured to cool the stator coil in contact with the stator coil, and is provided to be isolated from the stator core,
wherein the cooling portion includes a first heat sink that is provided to be opposed to a first end surface of the stator core in an axial direction of the stator core,
wherein a coil end portion of each of the phase coil portions is fixed to the first heat sink in a surface-contact state by a coil fixing member that is provided at the coil end portion of each of the phase coil portions, and has thermal insulation performance,
wherein an air gap is formed between an outer peripheral surface of the stator core and an inner peripheral surface of a cylindrical frame provided to surround the stator core,
wherein a first bracket is provided on one end portion of the frame on the first heat sink side to include the first heat sink, and is configured to close a first surface of the frame;
wherein a second bracket is provided on another end portion of the frame on a side opposite to the first bracket, and is configured to close a second surface of the frame,
wherein the stator core includes a plurality of stator core pieces, and
wherein, in an end surface of each of the stator core pieces, an oval hole is formed to allow each of the stator core pieces to move with respect to the first bracket in the radial direction of the stator core.

27. The rotary electric machine according to claim 26, wherein the first bracket and the second bracket, which are opposed to each other, are connected to both end portions of a plurality of coupling members provided on a radially outer side of the stator core.

28. The rotary electric machine according to claim 26, further comprising a second heat sink, which is provided on the second bracket to be opposed to a second end surface of the stator core in the axial direction of the stator core.

29. The rotary electric machine according to claim 26, wherein the first heat sink includes a refrigerant flow passage.

30. The rotary electric machine according to claim 26, wherein a thermal insulating medium is interposed between the conductive wire and the each of the plurality of tooth portions.
